(19) United States
(12) Patent Application Publication
(10) Pub. No.: US 2014/0000458 A1
(43) Pub. Date: Jan. 2, 2014

(54) REMODEL CONSTRUCTION AIR FILTER ASSEMBLY FOR A COLD AIR RETURN

(71) Applicant: Gary D. Ferguson, Wright City, MO (US)

(72) Inventor: Gary D. Ferguson, Wright City, MO (US)

(21) Appl. No.: 13/539,631

(22) Filed: Jul. 2, 2012

(51) Int. Cl. B01D 46/42; B01D 46/10

(52) U.S. Cl. 95/273; 55/501

(57) ABSTRACT

An air filter assembly for remodel construction has a housing with a frame configured to seat against a wall and about a cold air return. A grill defining a plurality of louvers and a rim is configured to cover at least a portion of the housing outer surface. The rim extends to a depth no greater than the thickness of the housing outer surface. A filter has a frame configured to receive filtration media, the filter shaped and sized for removable insertion into the slot of the housing.

### CROSS-REFERENCE TO RELATED APPLICATIONS

Not applicable.

### STATEMENT REGARDING FEDERALLY SPONSORED RESEARCH

Not Applicable.

### BACKGROUND

The invention relates to an air filter for heating and air conditioning systems, and more particularly, to an air filter assembly for use in remodel construction.

Indoor air quality is increasingly becoming an important health, political, scientific, and environmental concern. Airborne contaminants, such as dust and pollen, can circulate throughout a building via heating and cooling systems. This has become a concern to homeowners, healthcare facilities, and other industries. Improving air quality by removing such particles reduces the risk of infection or other ailments that result from air pollution caused by these airborne particles. In particular, good air quality is important for those who suffer from respiratory ailments such as asthma.

Heating and cooling systems typically include cleaners and filters that are positioned prior to flowing through the fan housing and into the duct system for delivery to the various areas of the building. However, these filters do not remove enough of the contaminants. Therefore, additional filtering of the airflow is needed before introduction of the air into the building.

Some new constructions of buildings have begun incorporating such filtering systems and methods. However, existing buildings cannot be remodeled using the same systems and methods. Remodeling an existing building differs substantially from new construction and is often more expensive. With new construction, everything in the structure is designed from scratch and can be installed with complete access to all areas before they are blocked behind walls or other structures. In contrast, remodeling requires different equipment, materials, supplies, and techniques because of the limited access to many areas, such as behind walls, and the inability to change much of the existing structure. For example, the ducting for heating and cooling systems, including the location of cold air returns and registers, are typically located behind or within the walls of the building and are difficult to reroute once new construction is completed.

Therefore, there is a need among consumers, healthcare facilities, and other industries for a cost-effective filter and grill assembly for installation in remodel construction.

### DESCRIPTION OF THE DRAWINGS

In the accompanying drawings which form part of the specification:

FIG. 1 is a front exploded perspective view of a filter and grill assembly mounted to a cold air return for a heating and cooling system according to an embodiment of the present invention;

FIG. 2 is a rear exploded perspective view of the filter and grill assembly according to an embodiment of the present invention;

FIG. 3 is a front view of a grill according to an embodiment of the present invention;

FIG. 4 is a rear view of the grill according to an embodiment of the present invention;

FIG. 5 is a front view of a frame assembly according to an embodiment of the present invention;

FIG. 6 is a rear view of the frame assembly according to an embodiment of the present invention; and

FIG. 7 is a front view of a filter according to an embodiment of the present invention.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

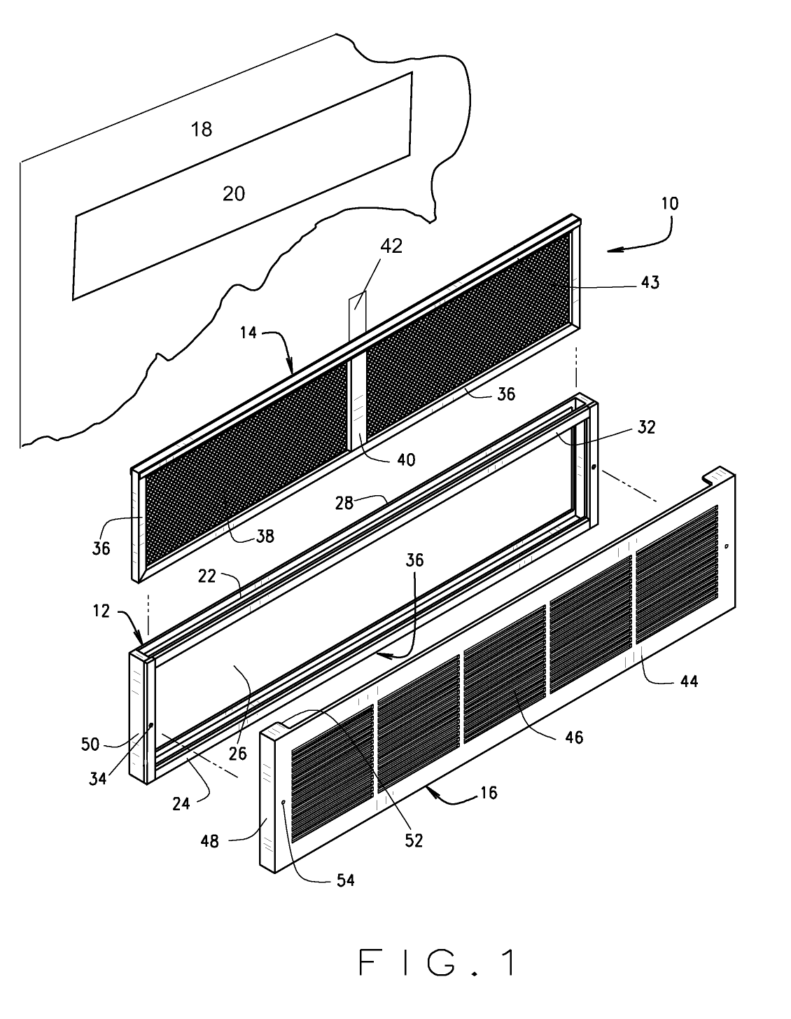

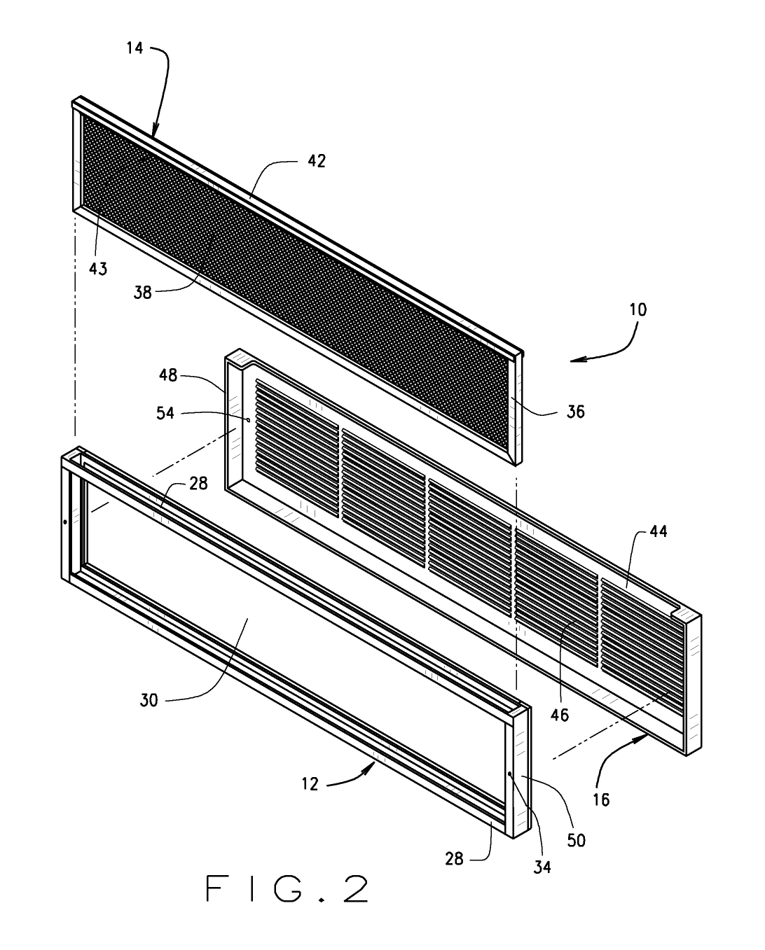

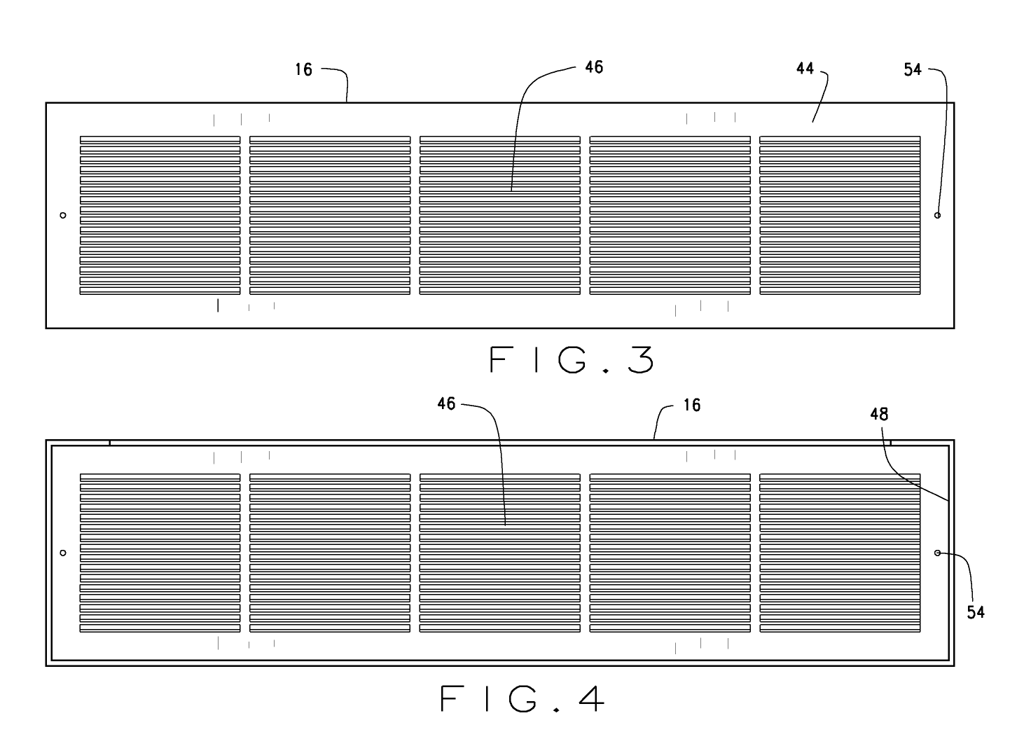

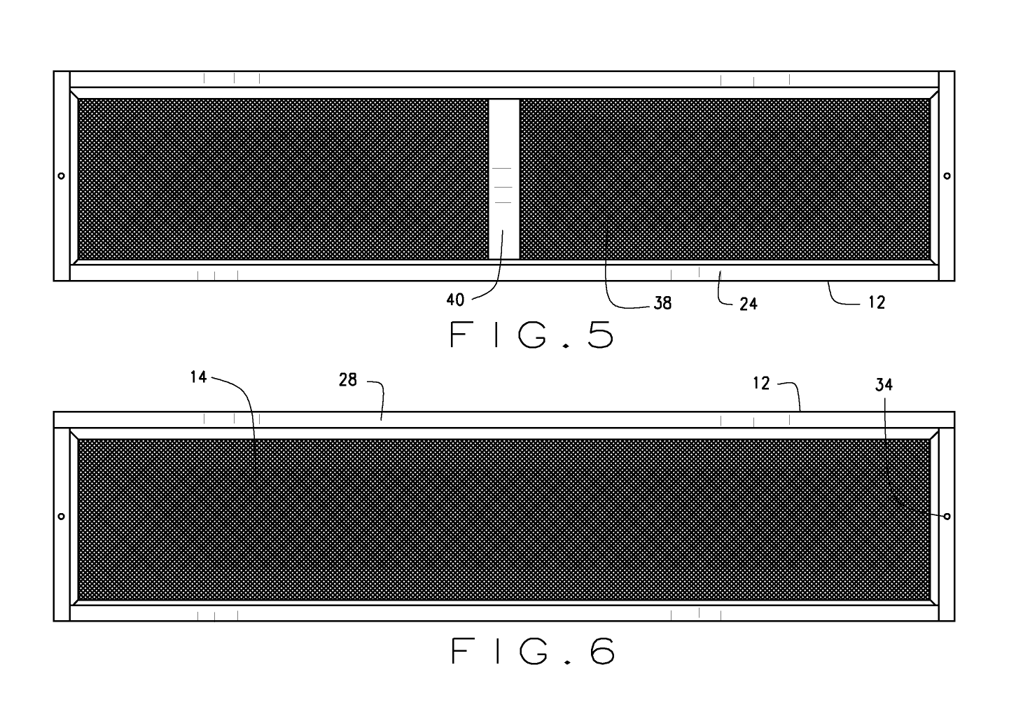

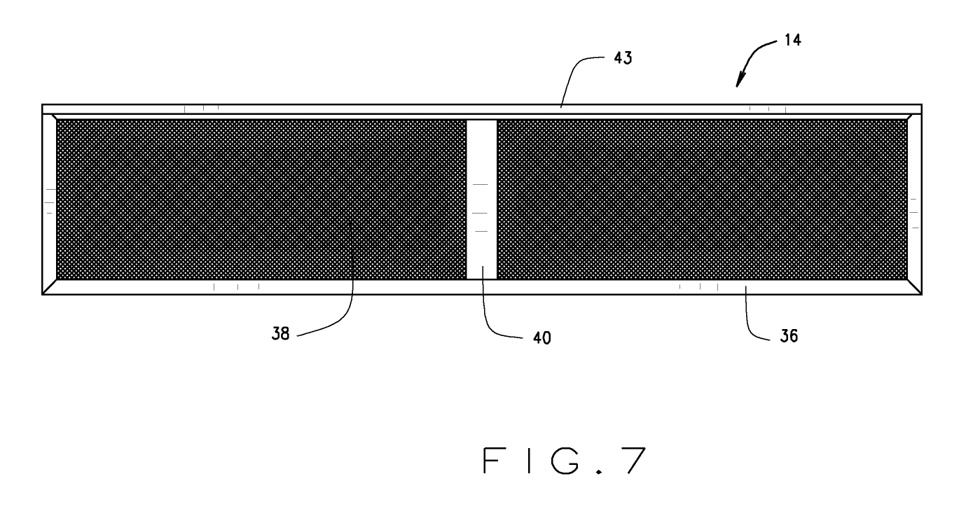

As shown in FIGS. 1-8, an embodiment constructed in accordance with the present disclosure, generally referred to as an air filter assembly 10 for remodel construction (or an existing building), includes a housing 12, a removable filter 14, and a grill 16. The air filer assembly 10 seals on a wall 18 about a cold air return 20 to filter air containments from the air flow.

The housing 12 is a generally rectangular prism that defines a generally rectangular prism shaped slot 22 sized and shaped to receive the filter 14. A front face 24 of the housing 12 defines an inlet opening 26 generally corresponding to the size and shape of the filter 14, but sized and shaped for retention of the filter within the slot of the housing. A rear face 28 of the housing 12 defines an outlet opening 30 generally corresponding to the size and shape of the filter 14, sized and shaped for retention of the filter within the slot of the housing. For example, the perimeter of the inlet opening and outlet opening can be slightly smaller than the border of the filter to overlap the perimeter of the filter 14 for securement. The housing 12 is preferably made from aluminum, but can be made from any suitable material, including, but not limited to, metals, wood, or polymers. Insulation strips 32 are attached, such as with adhesive or fasteners, along the border of the rear face 28 to seal against the wall 18 about the cold air return 20. The insulation strips 32 are preferably a foam material, but can be any suitable material that forms a seal between the housing 12 and wall 18, including, but not limited to, natural materials or synthetic materials. The housing 12 defines holes 34 for insertion of fasteners 36 and securement to the wall 18.

The filter 14 is a generally rectangular frame 36 shaped and sized for placement within the slot 22 of the housing 12. The frame 36 includes a perimeter preferably comprised of U-shaped channel sized and shaped for securement of filtration media 38. A crossbar 40 extends between an upper portion and lower portion of the frame 36 to support the filtration material. The filtration media 38 can be any material suitable to trap airborne contaminants, including, but not limited to natural materials, synthetic materials, metal, paper, foam, organza, and the like. A tab 42 extends upwardly from the filter 14, so that when the filter 14 resides in the housing 12, the tab 42 extends out of the housing 12. In this way, the tab 42 aids in removal of the filter from the housing 12. Insulation strips 43 are attached, such as with adhesive or fasteners, along the upper edge filter frame 36 to seal against an inner surface of the housing 12. The insulation strips 32 are preferably a foam material, but can be any suitable material that forms a seal between the housing 12 and wall 18, including, but not limited to, natural materials or synthetic materials.

The grill 16 is a generally rectangular panel 44 that is shaped and sized to generally cover the front and side surfaces of the housing 12. The panel 44 defines a plurality of louvers 46 configured to direct airflow. A rim 48 extends generally rearwardly from the perimeter of the panel 44. The length of the rim 48 generally corresponds to but does not exceed the width of an outer surface 50 of the housing 12. A top portion of the rim 48 defines an opening 52 that corresponds generally to the shape and size of the slot 22 of the housing 12 so that the filter 14 can be inserted and removed from the housing 12. The panel 44 defines holes 54 that generally aligns with the holes 34 in the housing 12 for insertion of fasteners and securement to the wall 18.

In operation, the housing 12 is positioned over the cold air return 20 with the insulation strips 32 sealed against the wall 18. The grill 16 seats against the front face 24 of the housing 12 with the rim 48 extending to cover the outer surface 50 of the housing 12. The opening 52 of the top portion of the rim 48 aligns with the slot 22 of the housing 12. Fasteners 36 insert through the holes 54 of the grill and holes 34 of the housing 12 and secure to the wall 18, preferably by insertion into studs. The filter 14 inserts into the slot 22 of the housing 12 with the tab extending out of the housing 12 for easier removal of the filter 14. After a designated period of use, the filter 14 can be removed for cleaning or replacement.

Changes can be made in the above constructions without departing from the scope of the disclosure, it is intended that all matter contained in the above description or shown in the accompanying drawings shall be interpreted as illustrative and not in a limiting sense.

What is claimed is:

1. An air filter assembly for remodel construction, comprising:
a housing configured to seat against a wall and about a cold air return, the defining a slot;
a grill defining a plurality of louvers and a rim configured to cover at least a portion of the housing, the rim extending to a depth no greater than the thickness of the housing; and
a filter having a frame configured to receive filtration media, the filter shaped and sized for removable insertion into the slot of the housing.

2. The air filter assembly of claim 1, further comprising insulation strips attached to a rear face of the housing to seal against the wall.

3. The air filter assembly of claim 1, further comprising a tab extending from the filter to aid in removal of the filter from the slot of the housing.

4. The air filter assembly of claim 1, wherein the housing defines a plurality holes, the grill defines a second plurality of holes aligned with the first plurality of holes; and further comprising fasteners that extend through the first and second plurality of holes for securement to the wall.

5. The air filter assembly of claim 1, wherein the housing includes a generally rectangular prism shaped frame having a front opening and a rear opening sized and shaped for retention of the filter within the slot of the housing.

6. A method of filtering contaminants from the air in an existing building, comprising the steps of:
providing a housing configured to seat against a wall and about a cold air return, the housing defining a slot;
providing a grill defining a plurality of louvers and a rim configured to cover at least a portion of the housing outer surface, the rim extending to a depth no greater than the thickness of the housing outer surface; and
providing a filter having a frame configured to receive filtration media, the filter shaped and sized for removable insertion into the slot of the housing;
securing the housing and grill to the wall and about the cold air return; and
inserting the filter into the slot of the housing;
flowing air through the filter;
removal of the filer from the housing.

7. The method of claim 6, further comprising the step of providing insulation strips attached to a rear face of the housing to seal against the wall.

8. The method of claim 6, further comprising the step of providing a tab extending from the filter to aid in removal of the filter from the slot of the housing.

9. The method of claim 6, wherein the housing defines a plurality holes, the grill defines a second plurality of holes aligned with the first plurality of holes; and the further comprising the step of providing fasteners that extend through the first and second plurality of holes for securement to the wall.

10. The method of claim 6, wherein the housing includes a generally rectangular prism shaped frame having a front opening and a rear opening sized and shaped for retention of the filter within the slot of the housing.

11. An air filter assembly for remodel construction, comprising:
a housing having a frame configured to seat against a wall and about a cold air return without any modifications to the wall or cold air return, the frame defining a slot;
a grill defining a plurality of louvers and a rim configured to seat against and cover at least a portion of the outer surface of the housing, the rim extending to a depth no greater than a thickness of the housing and defining a slot generally corresponding to the shape, size, and location of the slot of the housing; and
a filter having a frame configured to receive filtration media, the filter shaped and sized for removable insertion into the slot of the housing without removal of the grill from the housing.

12. The air filter assembly of claim 11, further comprising insulation strips attached to a rear face of the housing to seal against the wall.

13. The air filter assembly of claim 11, further comprising a tab extending from the filter to aid in removal of the filter from the slot of the housing.

14. The air filter assembly of claim 11, wherein the housing defines a plurality holes, the grill defines a second plurality of holes aligned with the first plurality of holes; and further comprising fasteners that extend through the first and second plurality of holes for securement to the wall.

15. The air filter assembly of claim 11, wherein the housing includes a generally rectangular prism shaped frame having a front opening and a rear opening sized and shaped for retention of the filter within the slot of the housing.
